(19) United States
(12) Patent Application Publication
(10) Pub. No.: US 2010/0161745 A1
(43) Pub. Date: Jun. 24, 2010

(54) Communication System and Terminal Registration Method Thereof, Server Unit, and Terminal Device

(76) Inventors: Shuji Yamazaki, Koganei-shi (JP); Shuichi Sato, Sagamihara-shi (JP); Fumio Shibasaki, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/608,665

(22) Filed: Oct. 29, 2009

(30) Foreign Application Priority Data
Dec. 18, 2008 (JP) 2008-322521

(51) Int. Cl. G06F 15/16; G06F 17/30

(52) U.S. Cl. 709/206; 709/207; 709/227; 707/E17.005

(57) ABSTRACT

According to one embodiment, there is provided a communication system includes endpoints and server units. The endpoints include a transmitter and an information assignment module. The transmitter transmits a message of the registration request to one of the server units. The information assignment module assigns information used to discriminate a cause of generation of the registration request to the message. The server units include a specification module, a determination module and a registration processor. The specification module specifies the cause based on the information assigned to the received message. The determination module determines whether or not permit registration of the endpoint as a source of the received message based on the specified cause and priority level. The registration processor registers the endpoint when the registration is permitted. The registration processor instructs the endpoint to redirect the message when the registration is not permitted.

### CROSS-REFERENCE TO RELATED APPLICATIONS

This application is based upon and claims the benefit of priority from Japanese Patent Application No. 2008-322521, filed Dec. 18, 2008, the entire contents of which are incorporated herein by reference.

### BACKGROUND

1. Field

The invention relates to a communication system, which forms a session between terminals via, e.g., an Internet Protocol (IP) network, a server unit and endpoint used in this system, and a terminal registration method.

2. Description of the Related Art

In recent communication systems, formation of a session between terminals via an IP network becomes mainstream. Of these systems, a Voice over IP (VoIP) system which makes speech communications using the IP network is typical. The VoIP protocols include the well-known Session Initiation Protocol (SIP), Media Gateway Control (Megaco), and H.248.

Management of a communication system has to consider survivability. The survivability is a term that represents a system performance or property that allows to keep providing services to users even when a failure has occurred in this technical field. The survivability includes some levels: for example, level 1 survivability.

The following mode will be examined. That is, when an IP telephone system includes a plurality servers and endpoints as communication terminals, one of these servers is distinguished as a home server from the other server as a backup server when viewed from each endpoint. In a normal state (non-failure state), an endpoint is connected to the home server. For example, assume that an endpoint detects a failure of the home server since there is no response to a KeepAlive message. Then, this endpoint immediately issues a connection request to the backup server, and then continues a communication while relying on the backup server as a connection destination. According to such system configuration, system reliability can be enhanced without doubling the servers themselves. The survivability implemented in this way is called level 1 survivability. The server in SIP means a so-called SIP server.

In order to connect an endpoint to a server, the endpoint has to issue a login request message to the server. The endpoint acquires an IP address of a partner to which this message is to be issued from a Dynamic Host Configuration Protocol (DHCP) server. However, since the DHCP server notifies the endpoint of a fixed IP address without any distinction between the home server and backup server, login requests are concentrated on a specific server.

When a server as a destination of the login request is the backup server for the endpoint as a source of that request (the endpoint cannot detect that fact in advance), the following problem occurs. That is, the existing technique does not have any means to discriminate on the server side whether or not the login request is based on the level 1 survivability. If the endpoint is connected to the backup server by the login request which is not based on the level 1 survivability (which request is issued by, e.g., turning on/off the power supply of the endpoint), a manual operation of a maintenance person is required to re-connect that endpoint to the primary home server. Since such problem is also posed not only in a system using the SIP but also in systems using other protocols, some measures are demanded.

Jpn. Pat. Appln. KOKAI Publication No. 2007-4361 discloses a technique which can form an environment similar to the level 1 survivability. This reference discloses a technique which attains load distribution by transferring a session from an SIP terminal to a low-load server to be preferentially connected by a distribution controller. However, in this reference, as described in paragraph [0008], the traffic transfer destination is changed depending on the load state of the SIP server, but no technique that distributes the registration destinations of terminals (endpoints) is disclosed.

As described above, in the existing technique, when the endpoint issues a login request to the backup server, there is no means to discriminate on the server side whether or not that request is based on the level 1 survivability. For this reason, the endpoint is often connected (registered) to a wrong server, thus posing a problem in terms of system management. Since a maintenance person has to enter commands so as to connect the endpoint to the primary server, there are needs to solve such problem. Even when commands are entered by processing on the machine side, the normality of the home server has to be checked as pre-processing of such entry, thus increasing the load on the system side. A technique that allows to connect each individual endpoint to a server as a primary connection partner from the beginning is expected to be provided.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a system view showing an embodiment of an IP telephone system according to the invention;

FIG. 2 is a functional block diagram showing an embodiment of IPTs #1 and #2 shown in FIG. 1;

FIG. 3 is a functional block diagram showing an embodiment of SIP servers #A and #B shown in FIG. 1;

FIG. 4 is a view showing an example of the contents of a management table 14a shown in FIG. 3;

FIG. 5 is a view showing an example of an IPT initial registration sequence according to an embodiment of the invention; and

FIG. 6 is a view showing an example of an IPT re-registration sequence when a failure has occurred in an SIP server.

### DETAILED DESCRIPTION

Various embodiments according to the invention will be described hereinafter with reference to the accompanying drawings. In general, according to one embodiment of the invention, there is provided a communication system includes a plurality of endpoints configured to make telephone communications and a plurality of server units which receive registration requests from these endpoints in different priority levels. Each of the endpoints includes a transmitter and an information assignment module. The transmitter transmits a message of the registration request to one of the server units. The information assignment module assigns identification information used to discriminate a cause of generation of the registration request to the message. Each of the server units includes a specification module, a determination module and a registration processor. The specification module specifies the cause based on the identification information assigned to the received message. The determination module determines whether or not to permit registration of the endpoint as a source of the received message based on the specified cause and the priority level. The registration processor registers the endpoint when the determination module permits the registration. The registration processor instructs the endpoint to redirect the message when the determination module does not permit the registration.

By taking such means, identification information indicating a cause of generation of a registration request is written in that registration request message. For example, the identification information indicates whether that registration processing is that to be executed as a routine at the startup timing of a terminal (registration from a non-registered state) or is that based on the level 1 survivability (re-registration from an already registered state). The identification information is written in, an extended field assured in the registration request message. The server unit can determine whether or not to permit registration by reading information in this extended field.

That is, in case of a re-registration request resulting from a failure, the server unit can immediately register that terminal. In case of an initial registration request, the server unit can determine a server as a primary connection destination based on distinction of a home server/backup server, and can give an appropriate instruction (e.g., a redirect request) to the endpoint. Therefore, each individual endpoint can be connected to a server to be primarily connected from the beginning.

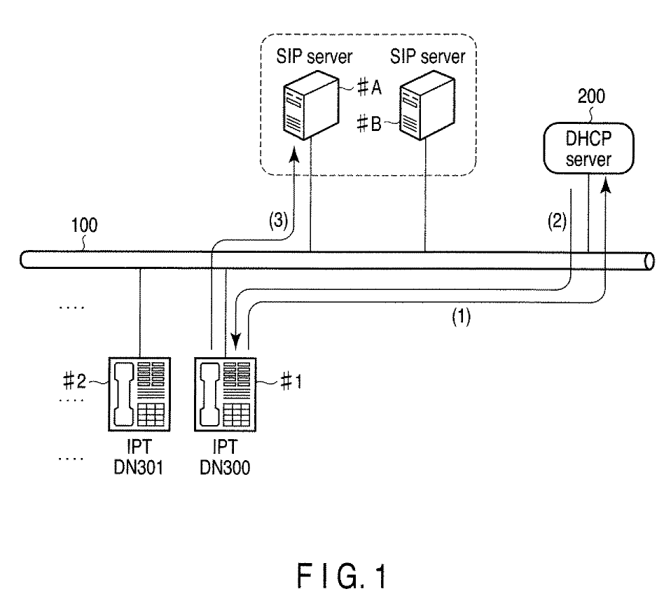

FIG. 1 is a system view showing an embodiment of an IP telephone system according to the invention. This system is formed by connecting SIP servers #A and #B, and a plurality of IP terminals (IPTs) #1 and #2 as endpoints via a common IP network 100. Of course, the number of IPTs is not limited to two, and many IPTs are connected to the IP network 100 and are registered in either of SIP servers #A and #B. SIP servers #A and #B execute control for forming a session between IPTs on the IP network 100.

Each of IPTs #1 and #2 has a telephone communication function via a session formed on the IP network 100. A terminal of this type includes a multi-function telephone, a computer installed with speech communication software (software phone), and a cellular phone terminal. Also, the terminal includes that which is connected to a personal computer or personal digital assistant (PDA) and has a function of transmitting/receiving multimedia data. Furthermore, the terminal includes an advanced portable phone called Smartphone. The Smartphone has both the function of a mobile or PHS terminal and that of the PDA.

The IP network 100 is, for example, a local area network (LAN). To the IP network 100, a Dynamic Host Configuration Protocol (DHCP) server 200 having functions of issuing an IP address, notifying the IP address information of SIP servers #A and #B, and the like is also connected.

SIP servers #A and #B have a function of processing the level 1 survivability. That is, SIP servers #A and #B form one server system, which has a function of controlling a plurality of IPTs. That is, each of SIP servers #A and #B is associated in advance with one of a home server and a backup server having a lower priority than the home server for each IPT. This association can be attained by associating the uniform resource indicator (URI) of each IPT with identifiers of respective servers.

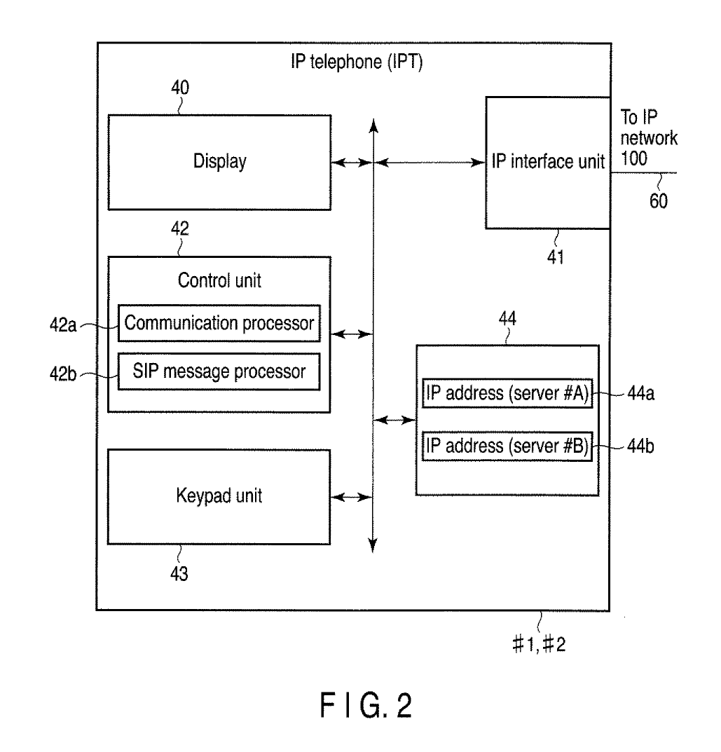

FIG. 2 is a functional block diagram showing an embodiment of IPTs #1 and #2 shown in FIG. 1. Each of IPTs #1 and #2 includes an interface unit 41 which is connected to the IP network 100 via a LAN cable 60, a display 40, a control unit 42, a keypad unit 43, and a memory 44. Of these units, the display 40 includes a liquid crystal display (LCD), and displays various messages. The keypad unit 43 includes software keys, numeric keys, special keys, and the like, and accepts user's input operations.

The memory 44 is a rewritable semiconductor memory device such as a flash memory. The memory 44 holds the IP addresses of the servers #A and #B which are notified from the DHCP server 200 in, e.g., a startup routine of the IPT. In addition, the memory 44 stores the URI of the IPT, and the IPT issues a registration request to one of the SIP servers based on this URI.

The control unit 42 includes a communication processor 42a and SIP message processor 42b. The communication processor 42a controls communications via the IP network 100. For example, the communication processor 42a transfers SIP messages received via the IP network 100 to the SIP message processor 42b and outputs SIP messages transferred from the SIP message processor 42b onto the IP network 100, in addition to control of speech communications. For example, in order to issue a registration request of its IPT to the system, the communication processor 42a transmits a REGISTER message to the IP address of one of the servers #A and #B.

The SIP message processor 42b generates and interprets SIP messages. The operation of the SIP message processor 42b follows the user agent (UA) specifications of the SIP described in, e.g., RFC 3261. Each SIP message is generated in response to generation of an event such as an input operation on, e.g., the keypad unit 43. The contents of an SIP message are interpreted in response to reception of that SIP message by the communication processor 42a, and the interpretation result is displayed on, e.g., the display 40, thus notifying the user of the message contents.

Furthermore, the SIP message processor 42b describes identification information used to discriminate a cause of generation of a registration request in an extended field of a REGISTER message as a processing function according to this embodiment. That is, there are various causes when the IPT issues a registration request to the SIP server, but two out of these causes will be considered in this case: “initial registration” and “re-registration”.

The initial registration is registration processing as the procedures embedded in the startup routine of the IPT or the like. The initial registration is not registration processing launched upon detection of a failure, and is not directly related to the level 1 survivability. By contrast, the re-registration is mainly caused by detection of a failure by the IPT, and is one of processes based on the level 1 survivability.

Tables 1 and 2 show description examples of a REGISTER message.

TABLE 1

REGISTER sips:example.co.jp SIP/2.0
Via: SIP/2.0/TLS

client.example.co.jp:5061;branch=z9hG4bKnashds7

Max-Forwards: 70
From: ABC ;tag=a73kszlfl
To: ABC
Call-ID: 1j9FpLxk3uxtm8tn@example.co.jp
CSeq: 300 REGISTER
Contact:
Content-Length: 0
User-Agent: extended_register_first_register

Table 1 shows an example of a REGISTER message which is sent to the server unit at the time of the initial registration. Information “extended_register_first_register” is written in an extended field indicated by User-Agent: in the lowermost line. This is identification information indicating the initial registration, and the server unit can recognize that this REGISTER message is not a registration request based on the level 1 survivability by interpreting this information.

TABLE 2

REGISTER sips:example.co.jp SIP/2.0
Via: SIP/2.0/TLS

client.example.co.jp:5061;branch=z9hG4bKnashds7

Max-Forwards: 70
From: ABC ;tag=a73kszlfl
To: ABC
Call-ID: 1j9FpLxk3uxtm8tn@example.co.jp
CSeq: 300 REGISTER
Contact:
Content-Length: 0
User-Agent: extended_register_fault_switchover

Table 2 shows an example of a REGISTER message which is sent to the server unit at the time of the re-registration. Information “extended_register_fault_switchover” is written in an extended field of the lowermost line. This is identification information indicating the re-registration, and the server unit can recognize that this REGISTER message is a registration request based on the level 1 survivability by interpreting this information.

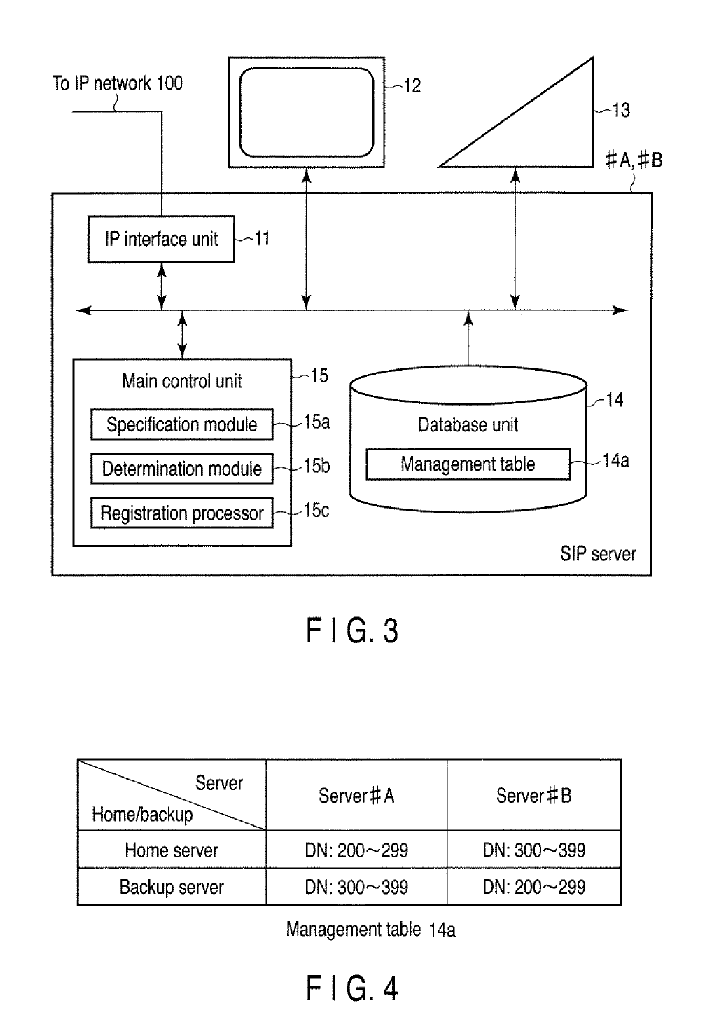

FIG. 3 is a functional block diagram showing an embodiment of SIP servers #A and #B shown in FIG. 1. Each of SIP servers #A and #B includes an interface unit 11, display unit 12, input/output unit 13, database unit 14, and main control unit 15. The interface unit 11 is connected to the IP network 100 to execute processing associated with packet exchange. The display unit 12 provides a user interface together with the input/output unit 13, and builds up a graphical user interface (GUI) environment. The database unit 14 is a storage device such as a hard disc drive, and stores a management table 14a.

The main control unit 15 includes a specification module 15a, a determination module 15b and a registration processor 15c. The specification module 15a specifies the cause based on the identification information assigned to the received REGISTER message. The determination module 15b determines whether or not to permit registration of the IPT as a source of the REGISTER message based on the specified cause and the priority level. The registration processor 15c registers the IPT when the determination module 15b permits the registration. The registration processor 15c instructs the IPT to redirect the REGISTER message when the determination module 15b does not permit the registration.

FIG. 4 is a view showing an example of the management table 14a. This table 14a manages association between the home server and backup server for each IPT by associating the identifiers of the home server and backup server with each other for each domain name (DN) of the IPT. The level 1 survivability is set based on this management table 14a. As shown in FIG. 4, the IPTs having a DN=200 to 299 use server #A as the home server, and server #B as the backup server. Conversely, as shown in FIG. 4, the IPTs having a DN=300 to 399 use server #B as the home server, and server #A as the backup server.

In the example of FIG. 4, a total of 200 IPTs are connected to the IP telephone system, and 100 IPTs each are set to be distributed and registered in the two servers. With these settings, a merit of the level 1 survivability can be obtained, i.e., the IPTs can be registered to have pre-set distributions without being biased on a specific server. The operation in this embodiment will be described below.

The normal terminal registration procedures will be described first with reference to FIG. 1. IPT #1, which is initialized as a result of, e.g., power on/off, broadcasts an address acquisition request onto the IP network 100 (1). Upon reception of this request, the DHCP server 200 returns an IP address to be assigned to the IPT as a request source and the IP address of the SIP server as its connection destination (2).

The IPT automatically logs onto the SIP server using a DN set in advance in itself. In this case, the IPT issues a REGISTER message to the SIP server notified from the DHCP server 200, but the IP address of the SIP server notified from the DHCP server 200 is fixed. This is because the DHCP server 200 does not have any management table 14a.

That is, the IP addresses of the SIP servers that the DHCP server 200 notifies the IPT are always in the order of, e.g., SIP servers #A and #B. This means that the IPT issues a connection request to SIP server #A first (3). When a connection has failed due to a failure of server #A, the IPT issues a connection request to server #B.

A case will be examined below wherein IPT #1 is initialized under the aforementioned conditions. IPT #1 issues a REGISTER request using a DN=300 to server #A using the IP address and that of the SIP server as the connection destination, which are received from the DHCP server. Server #A can recognize that the home server of the terminal which issued the REGISTER request and has the DN=300 is server #B (with reference to the management table 14a). However, in the related art, server #A cannot determine whether or not this REGISTER request is issued based on the level 1 survivability. Therefore, server #A has no other choice but to register IPT #1 in itself. In this case, IPT #1 is kept connected to server #A which is not the primary connection destination and is the backup server. The operation for solving this problem will be described below.

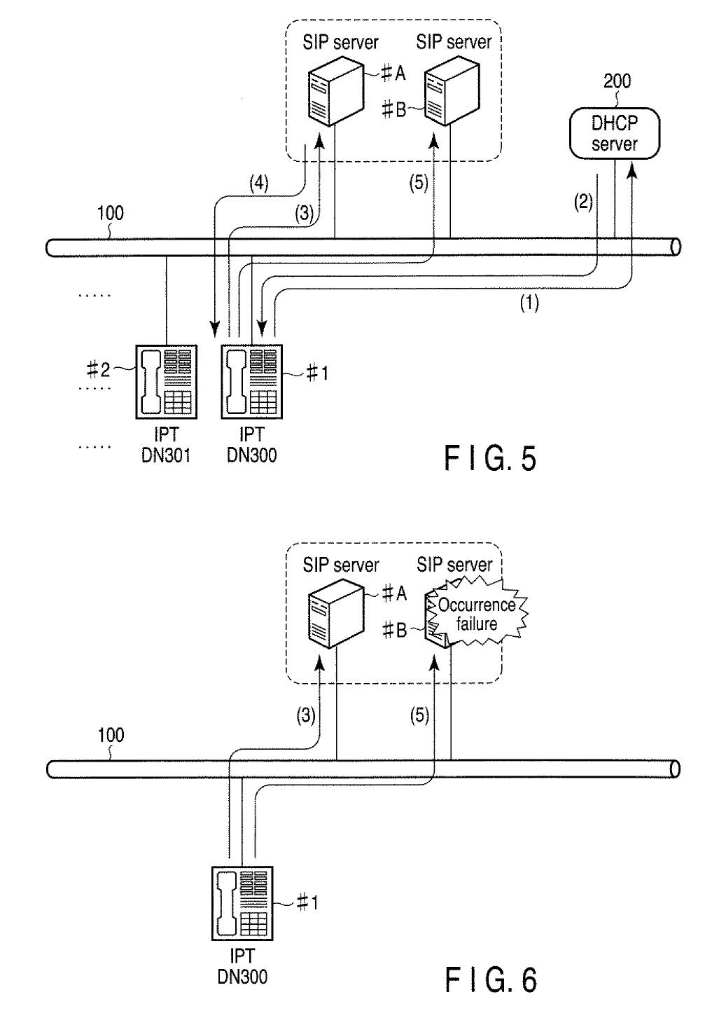

FIG. 5 is a view showing an example of the IPT initial registration sequence according to this embodiment. Referring to FIG. 5, procedures (1) and (2) are the same as those in FIG. 1, and IPT #1 issues a REGISTER request to SIP server #A in (3). Note that identification information (Table 1) indicating connection which is not based on the level 1 survivability is written in this REGISTER message.

Upon reception of the REGISTER request, server #A recognizes itself to be the backup server with reference to the management table 14a, since the DN of the request source IPT #1 is 300. Hence, server #A checks whether or not registration is based on the level 1 survivability function with reference to the extended part of the REGISTER message. In this case, the registration is not based on the level 1 survivability function. Therefore, server #A issues a redirect request to IPT #1 to instruct IPT #1 to output a REGISTER request to server #B again (4). Upon reception of this request, IPT #1 issues a REGISTER request to server #B. Server #B recognizes itself to be the home server for IPT #1, and registers IPT #1 as a DN=300 in itself.

With the aforementioned procedures, when both the SIP servers as the home server and backup server normally operate, the IPT which issued the registration request is certainly registered in the home server.

FIG. 6 is a view showing the IPT re-registration sequence when a failure has occurred in the SIP server. FIG. 6 illustrates a state in which the level 1 survivability functions. Assume that a failure occurs in server #B after IPT #1 receives notification of the server address via the procedures (1) and (2) in FIG. 1.

Then, IPT #1 detects occurrence of a failure in server #B by detecting that, for example, no response to a KeepAlive message is returned, and issues a REGISTER request to server #A as the backup server. In this case, IPT #1 appends identification information (Table 2) indicating connection based on the level 1 survivability to this REGISTER message.

Upon reception of the REGISTER request from IPT #1, server #A recognizes itself to be the backup server for IPT #1 since the DN of IPT #1 is 300. Furthermore, server #A checks whether or not registration is based on the level 1 survivability with reference to the identification information of the received REGISTER request. In case of FIG. 6, since the message explicitly indicates the registration based on the level 1 survivability function, server #A immediately registers IPT #1. After that, IPT #1 is connected to server #A and starts communications.

As described above, according to this embodiment, an extended field is assured on a REGISTER message as a registration request to the SIP server, and identification information explicitly indicating whether or not to execute re-registration based on the level 1 survivability is described in this extended field. Hence, upon reception of the REGISTER message, the SIP server can immediately issue an instruction (redirect request) to re-connect to the home server to the IPT which issued a connection request to the backup server when the level 1 survivability is not a cause of the request. Therefore, the IPT is not registered in the backup server, and is registered in the home server as a primary connection destination.

On the other hand, the IPT, which issued a REGISTER request to the backup server due to an operation of the level 1 survivability resulting from a failure, is registered in the backup server intact. In this case, the backup server can obtain required information by referring to only information in the extended field of the SIP message. Therefore, the backup server does not require any procedure for checking the status of the home server, thus obtaining merits of reducing the processing load and network load.

As described above, a communication system which allows each individual endpoint to a server as a primary connection partner, a terminal registration method thereof, a server unit, and a terminal device can be provided.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication system comprising:
a plurality of endpoints configured to make telephone communications; and
a plurality of server units which receive registration requests from these endpoints in different priority levels,
each of the endpoints comprising:
a transmitter configured to transmit a message of the registration request to one of the server units; and
an information assignment module configured to assign identification information used to discriminate a cause of generation of the registration request to the message, and
each of the server units comprising:
a specification module configured to specify the cause based on the identification information assigned to the received message;
a determination module configured to determine whether or not to permit registration of the endpoint as a source of the received message based on the specified cause and the priority level; and
a registration processor configured to register the endpoint when the determination module permits the registration, and to instruct the endpoint to redirect the message when the determination module does not permit the registration.

2. The system of claim 1, further comprising:
an address notification server which designates an address of the server unit as a destination of the message in the endpoint, and
in which the transmitter transmits the message to the address designated by the address notification server.

3. The system of claim 1, wherein the determination module permits the registration of the endpoint independently of the priority level when the cause is re-registration from an already registered state in another server unit.

4. The system of claim 1, wherein the plurality of server units are associated in advance with one of a home server and a backup server having a lower priority than the home server for each endpoint.

5. The system of claim 4, wherein each of the plurality of server units further comprises a management database to manage associations between the home server and the backup server for respective endpoints, and
the determination module permits the registration of the endpoint when the cause is registration from a non-registered state in the server unit, and the home server of the endpoint as the source is the server unit itself in the management database.

6. The system of claim 1, wherein the plurality of server units are Session Initiation Protocol (SIP) servers, and
the message is a REGISTER message of SIP messages.

7. A terminal registration method used in a communication system which comprises a plurality of endpoints configured to make telephone communications, and a plurality of server units which receive registration requests from these endpoints in different priority levels, the method comprising:
assigning, by each of the endpoints, identification information used to discriminate a cause of generation of a registration request to a message of the registration request to the server unit;
transmitting, by the endpoint, the message assigned with the identification information, to one of the server units;
specifying, by the server unit, the cause from the identification information assigned to the received message;
determining, by the server unit, whether or not to permit registration of the endpoint as a source of the received message based on the specified cause and the priority level; and
registering, by the server unit, the endpoint when the registration is permitted, and instructing the endpoint to redirect the message when the registration is not permitted.

8. The method of claim 7, wherein the endpoint transmits the message to an address designated by an address notification server which designates an address of the server unit as a destination of the message.

9. The method of claim 7, wherein the server unit permits the registration of the endpoint independently of the priority level when the cause is re-registration from an already registered state in another server unit.

10. The method of claim 7, wherein the plurality of server units are associated in advance with one of a home server and a backup server having a lower priority than the home server for each endpoint.

11. The method of claim 10, wherein the server unit determines whether or not the home server of the endpoint as the source is itself based on a management database configured to manage associations between the home server and the backup server for respective endpoints, and
the server unit permits the registration of the endpoint when the cause is registration from a non-registered state in the server unit, and the home server of the endpoint as the source is the server unit itself in the management database.

12. The method of claim 7, wherein the plurality of server units are Session Initiation Protocol (SIP) servers, and
the endpoint assigns the identification information to a REGISTER message of SIP messages.

13. A server unit used in a communication system which comprises a plurality of endpoints configured to make telephone communications, and a plurality of server units which receive registration requests from these endpoints in different priority levels, the server unit comprising:
a specification module configured to specify a cause of generation of a registration request from identification information which is assigned to a message of the registration request and is used to discriminate a cause of generation of the registration request;
a determination module configured to determine whether or not to permit registration of the endpoint as a source of the received message based on the specified cause and the priority level; and
a registration processor configured to register the endpoint when the determination module permits the registration, and instruct the endpoint to redirect the message when the determination module does not permit the registration.

14. The server unit of claim 13, wherein the determination module permits the registration of the endpoint independently of the priority level when the cause is re-registration from an already registered state in another server unit.

15. The server unit of claim 13, wherein the server unit is associated in advance with one of a home server and a backup server having a lower priority than the home server for each endpoint.

16. The server unit of claim 15, which further comprises a management database configured to manage associations between the home server and the backup server for respective endpoints, and
in which the determination module permits the registration of the endpoint when the cause is registration from a non-registered state in the server unit, and the home server of the endpoint as the source is the server unit itself in the management database.

17. A terminal device used in a communication system which comprises a plurality of terminal devices configured to make telephone communications, and a plurality of server units which receive registration requests from these terminal devices in different priority levels, the terminal device comprising:
a transmitter configured to transmit, to one of the server units, a message of a registration request to the server unit; and
an information assignment module configured to assigns identification information used to discriminate a cause of generation of the registration request to the message.

18. The terminal device of claim 17, wherein the identification information is assigned to a REGISTER message of Session Initiation Protocol (SIP) messages.
